(19) United States
(12) Patent Application Publication
(10) Pub. No.: US 2026/0057037 A1
(43) Pub. Date: Feb. 26, 2026

(54) CIRCUIT AND METHOD FOR PREDICTING SOFTMAX LOW-PROBABILITY OUTPUT AND SOFTMAX CALCULATOR

(71) Applicant: Korea Electronics Technology Institute, Seongnam-si (KR)

(72) Inventors: Hyeonseong KIM, Yongin-si (KR); Byungsoo KIM, Yongin-si (KR)

(21) Appl. No.: 18/982,533

(22) Filed: Dec. 16, 2024

(30) Foreign Application Priority Data
Aug. 20, 2024 (KR) 10-2024-0111464

(51) Int. Cl. G06F 17/18; G06F 5/01; G06F 7/02

(52) U.S. Cl. CPC G06F 17/18; G06F 5/01; G06F 7/02

(57) ABSTRACT

Proposed are a circuit and method for predicting a softmax low-probability output, and a softmax calculator. The circuit may include a first-in first-out (FIFO) memory configured to store all elements of a quantized input vector, and an accumulator configured to cumulatively add all the elements. The circuit may also include a shifter configured to calculate an arithmetic mean of all the elements by performing a right shift on a cumulative sum of all the elements. The circuit may further include a subtractor configured to calculate a result of subtracting the arithmetic mean from a specific one of all the elements, and a comparator configured to compare the subtraction result with a specific constant.

### CROSS-REFERENCE TO RELATED APPLICATION

This application claims priority to and the benefit of Korean Patent Application No. 10-2024-0111464, filed on Aug. 20, 2024, the disclosure of which is incorporated herein by reference in its entirety.

### BACKGROUND

### Technical Field

The present disclosure relates to a softmax low-probability output prediction circuit for predicting whether the calculation of a non-linear function is unnecessary for a hardware-optimized transformer calculation, and a softmax calculator including the same.

### Description of Related Technology

Among artificial intelligence (AI) models, a transformer model has achieved excellent performance not only in natural language processing but also in vision and thus is attracting attention as a core technology for AI computation. A transformer model may perform an attention mechanism on the basis of three matrices of query, key, and value to identify the relationship between elements of sequence data or may emphasize important parts of an image to improve AI performance. Despite the excellent performance of transformer models, it is difficult to manufacture a dedicated accelerator.

### SUMMARY

One aspect is a hardware-efficient circuit for predicting a softmax low-probability output which does not perform division with high calculation complexity on all elements existing in a softmax input vector and may skip some unnecessary softmax calculations through softmax low-probability prediction calculations with low calculation complexity when performing an attention which is a main mechanism of a transformer using a distribution of attention maps of the transformer, and a softmax calculator including the same.

Aspects of the present disclosure are not limited to those described herein, and other aspects that have not been described above will be clearly understood by those of ordinary skill in the art from the following description.

Another aspect is a circuit for predicting a softmax low-probability output which is for hardware-optimized quantized transformer calculation.

The circuit for predicting a softmax low-probability output includes a first-in first-out (FIFO) memory configured to store all elements of a quantized input vector, an accumulator configured to cumulatively add all the elements, a shifter configured to calculate an arithmetic mean of all the elements by performing a right shift on a cumulative sum of all the elements, a subtractor configured to calculate a result of subtracting the arithmetic mean from a specific one of all the elements, and a comparator configured to compare the subtraction result with a specific constant.

The specific constant may be determined on the basis of a size of the input vector and a number of quantization bits applied to the input vector.

The size of the input vector may be represented as an integer power of 2.

Another aspect is a softmax calculator including a softmax low-probability output prediction circuit configured to calculate a result of subtracting an arithmetic mean of all elements of a quantized input vector from each element of the input vector and compare the subtraction result with a specific constant, a controller configured to determine whether a softmax output for each of the elements corresponds to a low-probability output on the basis of a comparison result between the subtraction result and the specific constant, a maximum searcher configured to search for a maximum value of all the elements, an exponent calculator configured to receive a quantization scale, calculate original values and an original maximum value of all the elements by multiplying all the elements and the maximum value of all the elements by the quantization scale, and calculate, for all the elements of the input vector, values of an exponentiation function that has a difference between each of the original values and the original maximum value as an exponent and Euler's number as a base, and a divider.

An accumulator included in the softmax low-probability output prediction circuit cumulatively adds the values of the exponentiation function.

The divider calculates a softmax value for a specific one of all the elements on the basis of a cumulative sum of the values of the exponentiation function and a value of the exponentiation function.

When a softmax output for the specific element corresponds to a low-probability output, the controller sets the divider to an inactive state and controls an output part to output the softmax output for the specific element as 0.

The specific constant may be determined on the basis of a size of the input vector and a number of quantization bits applied to the input vector.

The size of the input vector may be represented as an integer power of 2.

The softmax low-probability output prediction circuit may include a FIFO memory configured to store all the elements, the accumulator configured to cumulatively add all the elements, a shifter configured to calculate the arithmetic mean by performing a right shift on a cumulative sum of all the elements, a subtractor configured to calculate a result of subtracting the arithmetic mean from the specific one of all the elements, and a comparator configured to compare the subtraction result with the specific constant.

The accumulator may include a low-precision adder and a high-precision adder.

The low-precision adder may be an adder that performs addition using a smaller number of bits than the high-precision adder.

The low-precision adder may be used for cumulatively adding all the elements, and the high-precision adder may be used for cumulatively adding the values of the exponentiation function.

Another aspect is a method of predicting a softmax low-probability output which is for hardware-optimized quantized transformer calculation.

The method includes storing all elements of a quantized input vector in a FIFO memory, cumulatively adding all the elements using an accumulator, performing, by a shifter, a right shift on a cumulative sum of all the elements to calculate an arithmetic mean of all the elements, calculating, by a subtractor, a result of subtracting the arithmetic mean from a specific one of all the elements, and comparing, by a comparator, the subtraction result with a specific constant and determining, by a controller, whether a softmax output for the specific element corresponds to a low-probability output on the basis of a comparison result between the subtraction result and the specific constant.

The specific constant may be determined on the basis of a size of the input vector and a number of quantization bits applied to the input vector.

The size of the input vector may be represented as an integer power of 2.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings.

FIG. 1 is a block diagram of a basic softmax calculator.

FIG. 2 is a block diagram of a softmax calculator including a softmax low-probability output prediction circuit according to an exemplary embodiment of the present disclosure.

FIG. 3 is a flowchart illustrating a softmax calculation method according to an exemplary embodiment of the present disclosure.

FIG. 4 is a flowchart of a softmax low-probability output prediction method according to an exemplary embodiment of the present disclosure.

FIG. 5 is a block diagram of a computer system for implementing a method according to an exemplary embodiment of the present disclosure.

### DETAILED DESCRIPTION

A transformer model requires a large number of parameters, high-precision arithmetic operations, and many data offloading operations, which are the main factors that make efficient hardware implementation difficult. To implement efficient hardware for transformer calculations, various quantization techniques are being developed, parameter sizes are being reduced, and calculations based on integer data rather than real number data are being proposed. However, it is problematic to implement a non-linear function used in the attention mechanism.

Particularly, in the case of the softmax function, the hardware complexity for exponentiation and division is high. Here, an n^{th} degree polynomial or a lookup table-based approximation technique is proposed for exponentiation, while division, depending on the algorithm, requires high latency (SRT algorithm) due to not supporting pipelines in hardware implementation or a high-precision arithmetic operation employing an exponential term as an input value (series expansion with the Newton-Raphson algorithm). In other words, the high complexity of division may be a factor of degradation in computation speed and energy efficiency of a transformer accelerator.

The reference list of the present disclosure is as follows. In this specification, each reference may be referred to by the number assigned to the document below.
1) A. Marchisio, D. Dura, M. Capra, M. Martina, G. Masera and M. Shafique, “SwiftTron: An Efficient Hardware Accelerator for Quantized Transformers”, 2023 International Joint Conference on Neural Networks (IJCNN), June 2023, pp. 1-9, https://doi.org/10.1109/IJCNN54540.2023.10191521.
2) Yang Lin, Tianyu Zhang, Peiqin Sun, Zheng Li, Shuchang Zhou, “FQ-ViT: Post-Training Quantization for Fully Quantized Vision Transformer”, Proceedings of the Thirty-First International Joint Conference on Artificial Intelligence (IJCAI), pp. 1173-1179, 2022, https://doi.org/10.24963/ijcai.2022/164.
3) S. F. Obermann and M. J. Flynn, “Division algorithms and implementations”, IEEE Transactions on Computers, vol. 46, no.8, pp. 833-854, August 1997, https://doi.org/10.1109/12.609274.
4) M. Horowitz, “1.1 Computing's energy problem (and what we can do about it)”, 2014 IEEE International Solid-State Circuits Conference Digest of Technical Papers (ISSCC), pp. 10-14, 2014, https://doi.org/10.1109/ISSCC.2014.6757323.

The present disclosure relates to a device for predicting calculations that are unnecessary for a hardware-optimized transformer calculation. This specification particularly proposes a softmax low-probability output prediction circuit in which a quantized transformer predicts a median value of an attention calculation and skips some unnecessary non-linear function calculations to reduce latency of overall transformer inference calculations or increase energy efficiency, and a softmax calculator including the same.

According to [2], It is known that half the attention maps (softmax results) of a quantized transformer or more have small values close to 0. Therefore, a low attention-map (softmax result) value may be finally determined as a value of 0 in accordance with a quantization bit number B. In other words, a considerable number of softmax results may be quantized as 0 in consideration of the quantization bit number B. The present disclosure has been devised to reduce latency and power by performing, at a low cost, a softmax low-probability prediction calculation for identifying which input elements will be determined as 0 through quantization after a softmax calculation and skipping some complex softmax calculations in some cases.

For reference, a quantization level is determined in accordance with the quantization bit number B, and B-bit quantization represents that weights and activation values of a neural network are limited to 2^{B} unique values. For example, in 8-bit quantization, the number of unique values is limited to 256 (2⁸).

A softmax calculator according to the related art includes an e exponent calculator EXP, an accumulator, and a divider, while a softmax calculator according to the present disclosure further includes a shifter and a comparator to predict a softmax low probability.

The softmax calculator according to the present disclosure always performs a softmax low-probability prediction calculation before exponentiation or division to skip some softmax calculations which are performed for indices whose softmax calculation values are predicted to be low-probability values. In this way, it is possible to reduce latency and increase energy efficiency.

Advantages and features of the present disclosure and methods of achieving them will become clear with reference to exemplary embodiments described below in detail in conjunction with the accompanying drawings. However, the present disclosure is not limited to the embodiments disclosed below and may be implemented in various different forms. The embodiments are provided only to make the disclosure of the present disclosure complete and fully convey the scope of the present disclosure to those of ordinary skill in the art, and the present disclosure is only defined by the scope of the claims. Terminology used herein is for describing the embodiments and is not intended to limit the present disclosure. In this specification, a singular expression also includes the plural expression unless specifically stated otherwise. As used herein, “comprise” and/or “comprising” do not preclude the presence or addition of one or more components, steps, operation, and/or elements other than stated components, steps, operation, and/or elements.

Although the terms “first,” “second,” and the like are used to describe various components, the components are not limited by the terms. These terms are only used to distinguish one component from others. For example, a first component not departing from the scope of the present disclosure may be named a second component, and similarly, a second component may also be named a first embodiment.

When it is described that a first component is “connected” or “coupled” to a second component, the first component may be directly connected or coupled to the second component, or a third component may be therebetween. On the other hand, when it is described that a first component is “directly connected” or “directly coupled” to a second component, there is no other component therebetween. Other expressions that describe the relationships between components, such as “between,” “directly between,” “adjacent to,” “directly adjacent to,” and the like should be construed in the same manner.

In describing the present disclosure, when it is determined that the detailed description of associated known art may unnecessarily obscure the gist of the present disclosure, the detailed description will be omitted.

Hereinafter, exemplary embodiments of the present disclosure will be described in detail with reference to the accompanying drawings. In describing the present disclosure, the same reference numerals will be used for identical components throughout the drawings to facilitate overall understanding.

The present disclosure relates to a softmax calculator that is used for calculation of a quantized transformer model. Accordingly, the softmax calculator of the present disclosure uses a quantized value q as an input value. An original value x may be expressed as the product of a quantization scale s and the quantized value q (i.e., x=sq).

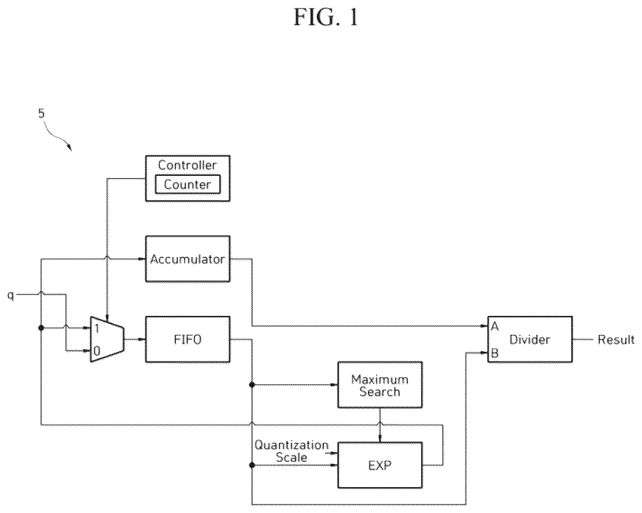

FIG. 1 is a block diagram of a basic softmax calculator.

A softmax calculator 5 of FIG. 1 may be used for calculation of a quantized transformer model.

The softmax calculator 5 is designed for softmax calculation of Expression 1.

$$softmax ( {x}_{i} ) = \frac{exp ( {x}_{i} )}{{\sum }_{j = 1}^{n} exp ( {x}_{i} )} = \frac{exp ( {x}_{i} - {x}_{max} )}{{\sum }_{j = 1}^{n} exp ( {x}_{i} - {x}_{max} )} \qquad Expression 1$$

Expression 1 shows a softmax output for an i^{th} element xᵢ of an input vector with n elements.

A structure of the softmax calculator 5 may be derived from FIG. 11 of [1] and includes a controller, an accumulator, a first-in first-out (FIFO) memory, a maximum searcher, an exponent calculator EXP, and a divider. The accumulator included in the softmax calculator 5 includes a high-precision adder to add exponent calculation values.

The softmax calculator 5 receives and stores quantized values q in the FIFO memory. Here, the controller controls a multiplexer such that the quantized values q are stored in the FIFO memory. The FIFO memory transmits the stored quantized values q in sequence to the maximum searcher, and the maximum searcher detects the maximum of the quantized values q and transmits the maximum value to the exponent calculator EXP.

The FIFO memory transmits the stored quantized values q in sequence to the exponent calculator EXP, and the exponent calculator EXP calculates values of exp(xⱼ−xₘₐₓ) in sequence on the basis of the received quantized values q, the maximum of the quantized values q, and a quantization scale s and transmits the values of exp(xⱼ−xₘₐₓ) to the FIFO memory. Here, the controller controls the multiplexer such that the values of exp(xⱼ−xₘₐₓ) are stored in the FIFO memory.

Also, the exponent calculator EXP transmits the values of exp(xⱼ−xₘₐₓ) to the accumulator, and the accumulator adds the values of exp(xⱼ−xₘₐₓ) to calculate a value of Σexp(xⱼ−xₘₐₓ).

The FIFO memory transmits the values of exp(xⱼ−xₘₐₓ) in sequence to a terminal B of the divider, and the accumulator transmits the value of Σexp(xⱼ−xₘₐₓ) to a terminal A of the divider. The divider calculates a softmax value through the calculation of Expression 1.

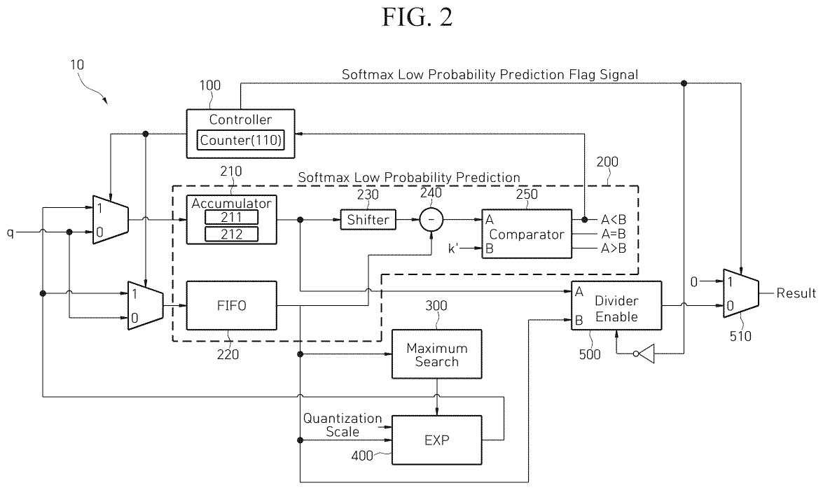

FIG. 2 is a block diagram of a softmax calculator including a softmax low-probability output prediction circuit according to an exemplary embodiment of the present disclosure.

A softmax calculator 10 according to an exemplary embodiment of the present disclosure is a device for performing hardware-efficient transformer calculations. The softmax calculator 10 has a structure obtained by adding a shifter 230, a subtractor 240, a comparator 250, and an output part 510 to the softmax calculator 5. A FIFO memory 220, a maximum searcher 300, an exponent calculator (EXP) 400, and a divider 500 are the same as those used in the softmax calculator 5.

A softmax low-probability output prediction circuit 200 included in the softmax calculator 10 includes an accumulator 210, the FIFO memory 220, the shifter 230, the subtractor 240, and the comparator 250. The accumulator 210 includes a low-precision adder 211 and a high-precision adder 212. Compared to the accumulator of the softmax calculator 5, the accumulator 210 further includes the low-precision adder 211. The high-precision adder 212 is used for cumulatively adding exponent calculation results, while the low-precision adder 211 additionally included in the accumulator 210 of the softmax low-probability output prediction circuit 200 according to the present disclosure is used for cumulatively adding each element xⱼ of an input vector to predict a softmax low-probability output. Therefore, the low-precision adder 211 may operate at a lower power than the high-precision adder 212. For reference, according to [4], int32 addition consumes 33 times as much energy as INT8 addition, and INT32 multiplication consumes 15 times as much energy as INT8 multiplication.

The softmax calculator 10 shown in FIG. 2 is in accordance with an exemplary embodiment. The components of the softmax calculator 10 according to the present disclosure are not limited to the exemplary embodiment shown in FIG. 2 and may be added, changed, or removed as necessary.

The softmax calculator 10 determines whether some softmax calculations are skippable during an attention calculation through the softmax low-probability output prediction circuit 200. The proposed softmax low-probability output prediction circuit 200 may be utilized in calculation by a quantized transformer model, and predicts a low softmax output, that is, a low probability value. Softmax low-probability output prediction calculation of the softmax low-probability output prediction circuit 200 may be derived from Expression 1.

Expression 2 is obtained by dividing each of the numerator and denominator of Expression 2 by n.

$$\frac{exp ( {x}_{i} )}{{\sum }_{j = 1}^{n} exp ( {x}_{i} )} = \frac{\frac{exp ( {x}_{i} )}{n}}{\frac{{\sum }_{j = 1}^{n} exp ( {x}_{i} )}{n}} \qquad Expression 2$$

The denominator on the right side of Expression 2 corresponds to an arithmetic mean. The arithmetic mean of exp(xⱼ) may be represented as shown on the left side of Expression 3, and the geometric mean of exp(xⱼ) may be represented as shown on the right side of Expression 3.

$$\frac{{\sum }_{j = 1}^{n} exp ( {x}_{j} )}{n} \geq \sqrt[n]{exp ( {x}_{1} ) \times exp ( {x}_{2} ) \times … \times exp ( {x}_{n} )} = exp ( \frac{{x}_{1} + {x}_{2} + … + {x}_{n}}{n} ) \qquad Expression 3$$

As shown in Expression 3, the arithmetic mean may have the minimum value when it is equal to the geometric mean. Therefore, the softmax function value of Expression 2 may have the maximum value when the geometric mean is substituted for the arithmetic mean which is the denominator on the right side of Expression 2. The maximum value may be represented as shown on the right side of Expression 4.

$$\frac{exp ( {x}_{i} )}{{\sum }_{j = 1}^{n} exp ( {x}_{j} )} \leq \frac{1}{n} exp ( {x}_{i} - \frac{{x}_{1} + {x}_{2} + … + {x}_{n}}{n} ) \qquad Expression 4$$

A quantized transformer takes a quantized softmax value as a softmax result, and when the maximum of softmax values is smaller than the minimum of quantization expressions, may predict the softmax result as 0. Accordingly, when a specific quantization bit number B is applied, a relational expression for predicting a softmax output of 0 even in consideration of the rounding of quantization may be represented as shown in Expression 5.

$$if \frac{1}{n} exp ( {x}_{i} - \frac{{x}_{1} + {x}_{2} + … + {x}_{n}}{n} ) < \frac{1}{{2}^{B + 1}} then , softmax ( {x}_{i} ) = 0 \qquad Expression 5$$

Here, to omit more softmax low-probability values while including softmax values that necessarily become 0 due to quantization, the relational expression for predicting a softmax low probability may be defined as shown in Expression 6 by adding a scale factor α. Here, the scale factor α has an integer value that is 1 or more and 2^{B+1} or less.

$$if \frac{1}{n} exp ( {x}_{i} - \frac{{x}_{1} + {x}_{2} + … + {x}_{n}}{n} ) < \frac{α}{{2}^{B + 1}} then , softmax ( {x}_{i} ) = 0 \qquad Expression 6$$

Expression 6 may be simplified as shown in Expressions 7 to 9 by applying a logarithm to both sides.

$$\frac{1}{n} exp ( {x}_{i} - \frac{{x}_{1} + {x}_{2} + … + {x}_{n}}{n} ) < \frac{α}{{2}^{B + 1}} \qquad Expression 7$$

$$1 n ( \frac{1}{n} exp ( {x}_{i} - \frac{{x}_{1} + {x}_{2} + … + {x}_{n}}{n} ) ) < 1 n ( \frac{α}{{2}^{B + 1}} ) \qquad Expression 8$$

$${x}_{i} - \frac{1}{n} {\sum }_{j = 1}^{n} {x}_{j} < 1 n ( n ) + 1 n ( α ) - ( B + 1 ) \cdot 1 n ( 2 ) \qquad Expression 9$$

On the right side of Expression 9, the quantization bit number B, the scale factor α, and a size (a number n of input elements) of the input vector are all values that may be determined during a design time. The quantization bit number B, the scale factor α, and the size (the number n of input elements) of the input vector are elements that are determined at an algorithm level in accordance with performance requested by a user, and when the required performance is specified, may be fixed at specific values during the hardware design time. The design time is a stage in which a circuit (resistor-transistor logic (RTL)) is designed to manufacture a hardware accelerator (chip). Accordingly, the right side of Expression 9 may be set to a specific constant k. Expression 10 is obtained by substituting the right side of Expression 9 with the specific constant k.

$${x}_{i} - \frac{1}{n} {\sum }_{j = 1}^{n} {x}_{j} < \qquad Expression 10$$

Meanwhile, calculating the left side of Expression 10 involves division by n. However, when n may be set to a power of 2 like in a hierarchical transformer model, division by n may be substituted with shift calculation.

As a result, the softmax calculator 10 may predict a low softmax output using the softmax low-probability output prediction circuit 200 with low complexity. For elements whose softmax outputs are determined as 0, the softmax calculator 10 may skip division by the divider 500 among original softmax calculations. When it is determined that softmax outputs for all the elements of the input vector are low (low probabilities) through the prediction calculation of Expression 10, the softmax calculator 10 may skip exponent calculation of the exponent calculator 400.

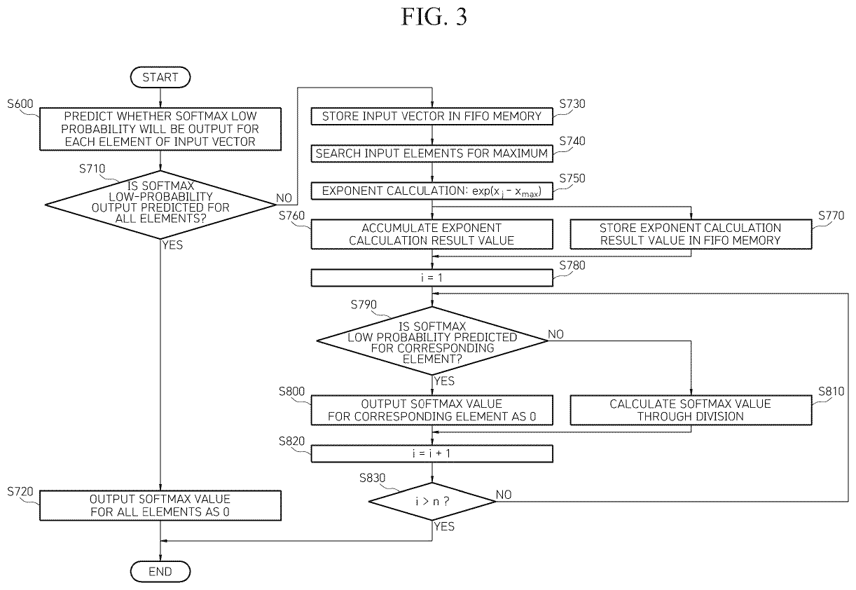

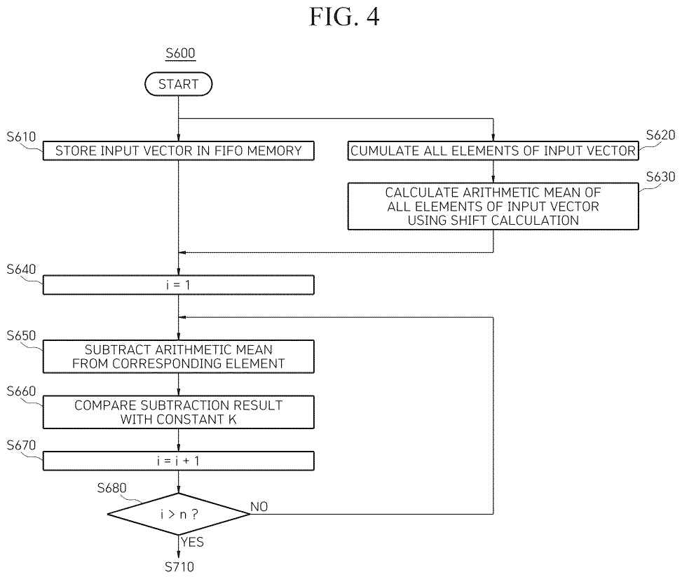

Operations of the softmax low-probability output prediction circuit 200 and the softmax calculator 10 equipped with the same will be described below with reference to FIGS. 3 and 4.

FIG. 3 is a flowchart illustrating a softmax calculation method according to an exemplary embodiment of the present disclosure, and FIG. 4 is a flowchart of a softmax low-probability output prediction method according to an exemplary embodiment of the present disclosure. The softmax calculation method is performed by the softmax calculator 10, and the softmax low-probability output prediction method is performed by the softmax low-probability output prediction circuit 200 included in the softmax calculator 10.

Referring to FIG. 3, the softmax calculation method according to an exemplary embodiment of the present disclosure includes operations S600 to S830. Referring to FIG. 4, the softmax low-probability output prediction method S600 according to an exemplary embodiment of the present disclosure includes operations S610 to S680. The softmax calculation method shown in FIG. 3 and the softmax low-probability output prediction method shown in FIG. 4 are in accordance with an exemplary embodiment. Operations of a softmax calculation method and a softmax low-probability output prediction method according to the present disclosure are not limited to the exemplary embodiment shown in FIGS. 3 and 4 and may be added, changed, or removed as necessary.

In operation S600, it is predicted whether a softmax low probability will be output for each element of an input vector.

As shown in FIG. 4, according to an exemplary embodiment of the present disclosure, operation S600 includes operations S610 to S680. In this specification, operations S610 to S680 may be referred to as a “softmax low-probability output prediction method.”

In operation S610, all elements of an input vector q are stored in the FIFO memory 220 in sequence. The controller 100 controls the multiplexer such that all the elements q₁, . . . , and qₙ of the input vector q are stored in the FIFO memory 220 in sequence. In the present embodiment, the size of the input vector q, that is, the number n of input elements, is assumed to be a power of 2(n=2^{p}). Here, p is an integer of 0 or more.

In operation S620, all the elements of the input vector are cumulatively added. The controller 100 controls the multiplexer to transmit all the elements q₁, . . . , and qₙ of the input vector q to the accumulator 210. Since the input vector q is composed of quantized values, the accumulator 210 cumulatively adds all the elements of the input vector q using the low-precision adder 211 and transmits the cumulative sum to the shifter 230. The softmax low-probability output prediction circuit 200 performs the cumulative addition using the low-precision adder 211 rather than the high-precision adder 212, and thus it is possible to reduce power consumption compared to the case of using the high-precision adder 212.

In operation S630, the arithmetic mean of all the elements of the input vector q is calculated using a shift calculation. The shifter 230 calculates the arithmetic mean of all the elements of the input vector q through the shift calculation and transmits the arithmetic mean to the subtractor 240. Since the size n of the input vector q is a power of 2(n=2^{p}), the softmax low-probability output prediction circuit 200 may shift the cumulative sum to the right by p(p=log₂ n) using the shifter 230 to calculate the arithmetic mean.

In operation S640, an input element index i is initialized as 1.

In operation S650, the arithmetic mean calculated in operation S630 is subtracted from an input element qᵢ specified the index. The FIFO memory 220 transmits the input element qᵢ corresponding to the input element index to the subtractor 240, and the subtractor 240 subtracts the arithmetic mean from the input element qᵢ and inputs the subtraction result to a terminal A of the comparator 250.

In operation S660, the subtraction result (A) of operation S650 is compared with a specific constant k′ (B).

The specific constant k′ is input to a terminal B of the comparator 250. k′ is a value obtained by dividing k of Expression 10 by the quantization scale s and may be determined during the design time. In other words, k′=(in(n)+1n(α)(B+1)1n (2))/s may be set, and the comparator 250 determines whether Expression 11 (A<B) given below holds. When Expression 11 holds, the comparator 250 transmits the comparison result to the controller 100. The controller 100 determines that a softmax low-probability output is predicted for the index i corresponding to A<B.

$${q}_{i} - \frac{1}{n} {\sum }_{j = 1}^{n} {q}_{j} < {k}^{′} \qquad Expression 11$$

In operation S670, the input element index i is increased by 1, and in operation S680, it is determined whether the input element index i is larger than the number n of input elements. When the input element index i is larger than the number n of input elements, operation S710 is performed, and otherwise, operations S650 and S660 are performed.

Referring back to FIG. 3, operation S710 and subsequent operations will be described below.

In operation S710, it is determined whether a softmax low-probability output is predicted for all the elements of the input vector q. When a softmax low-probability output is predicted for all the elements of the input vector q, the controller 100 performs operation S720. Otherwise, the controller 100 performs operation S730.

In operation S720, softmax values for all the elements are output as 0.

Since a softmax low-probability output is predicted for all the elements of the input vector q, the controller 100 skips the operations (operations S730 to S830) of calculating a softmax value and outputs softmax values for all the elements of the input vector q as 0 through the output part 510. The output part 510 is a multiplexer and outputs 0 or a softmax value calculated by the divider 500 in accordance with control by the controller 100.

In this way, when it is determined in operation S710 that a softmax low-probability output is predicted for all the elements of the input vector q, the exponent calculation operation which is operation S750 can be skipped, and thus it is possible to reduce power consumption and latency.

In operation S730, all the elements of the input vector q are stored in the FIFO memory 220 in sequence. The controller 100 controls the multiplexer such that all the elements q₁, . . . , and qₙ of the input vector q are stored in the FIFO memory 220 in sequence.

In operation S740, a maximum qₘₐₓ of input elements qⱼ of the input vector q is searched for.

The FIFO memory 220 transmits all the elements of the input vector q to the maximum searcher 300, and the maximum searcher 300 searches the input elements qⱼ for the maximum qₘₐₓ and transmits the maximum qₘₐₓ to the exponent calculator 400.

Operation S750 is an exponent calculation operation for calculating a value of an exponentiation function that has e (Euler's number) as a base and (xⱼ−xₘₐₓ) as an exponent.

The FIFO memory 220 transmits all the elements of the input vector q to the exponent calculator 400 in sequence. Also, the exponent calculator 400 externally receives the quantization scale s. The exponent calculator 400 calculates an original value xⱼ and a maximum xₘₐₓ by multiplying the input elements qᵢ and the maximum qₘₐₓ by the quantization scale s and calculates a value (an exponent calculation result value) of the exponentiation function that has e (Euler's number) as a base and (xⱼ−xₘₐₓ) as an exponent. The exponent calculator 400 transmits the exponent calculation result value to the accumulator 210.

In operation S760, the exponent calculation result value (exponentiation function value) is cumulatively added.

The accumulator 210 cumulatively adds the exponent calculation result value received from the exponent calculator 400 using the embedded high-precision adder 212. In other words, the accumulator 210 calculates the denominator on the right side of Expression 1.

In operation S770, the exponent calculation result value (exponentiation function value) is stored in the FIFO memory 220.

The exponent calculator 400 transmits the exponent calculation result value to the FIFO memory 220, and the exponent calculation result value is stored in the FIFO memory 220.

In operation S780, the input element index i is initialized as 1.

The controller 100 initializes the input element index i as 1.

In operation S790, it is determined whether a softmax low-probability output is predicted for an input element specified by the index.

When a softmax low-probability output is predicted for the input element index i, the controller 100 outputs a softmax value for the input element specified by the index as 0 (S800). As shown in FIG. 2, the controller 100 transmits a softmax low-probability prediction flag signal to the divider 500 to cause the divider 500 to be in a disable state and outputs a softmax value for the input element specified by the index i as 0 through the output part 510. Accordingly, division may be omitted for the input element specified by the index i for which a softmax low-probability output is predicted. In this case, due to the omission of division, latency and power consumption are reduced.

When a softmax low-probability output is not predicted for the input element index i, the controller 100 sets the divider 500 in an enable state to perform operation S810.

In operation S810, a softmax value is calculated through division.

The divider 500 receives the cumulative sum of exponent calculation result values corresponding to the denominator on the right side of Expression 1 from the accumulator 210 through a terminal A, receives an exponent calculation result (exp(xᵢ−xₘₐₓ)) corresponding to the numerator on the right side of Expression 1 from the FIFO memory through a terminal B, and calculates a softmax value for the input element xᵢ specified by the input element index i. The output part 510 outputs the softmax value calculated by the divider 500.

The controller 100 increases the input element index i by 1 (S820) and determines whether the input element index i is larger than the number n of input elements (S830). When the input element index i is larger than the number n of input elements, the process ends, and otherwise, operation S790 is performed.

A softmax calculation method and a softmax low-probability output prediction method have been described above with reference to the flowcharts shown in the drawings. For simplicity, the methods have been shown and described as blocks, but the present disclosure is not limited to the above sequence of blocks. Some blocks may occur simultaneously or in a different order than that shown and described in this specification, and various other branches, flow paths, and sequences of blocks may be implemented that achieve the same or similar results. In addition, not all the blocks shown in the drawings may be required for implementing the methods described herein.

In the description of FIGS. 3 and 4, depending on an implementation example of the present disclosure, each operation may be subdivided into additional operations, or operations may be combined into fewer operations. Also, as necessary, some operations may be omitted, or the sequence of operations may be changed. Further, the content of FIGS. 1 and 2 may be applied to the content of FIGS. 3 to 4 irrespective of omissions. In addition, the content of FIGS. 3 and 4 may be applied to the content of FIG. 2.

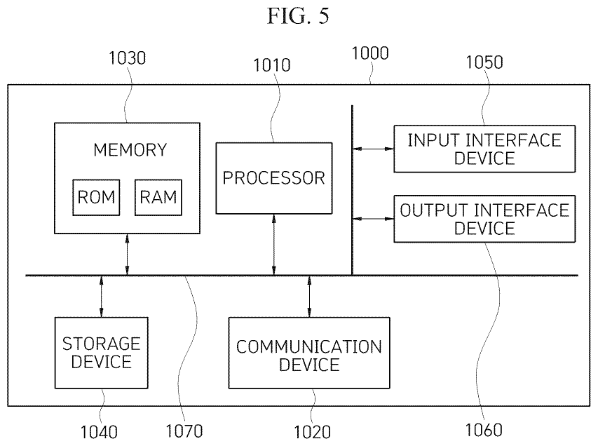

FIG. 5 is a block diagram of a computer system for implementing a method according to an exemplary embodiment of the present disclosure. The foregoing describes an embodiment in which the softmax calculator 10 performs the softmax calculation method of FIG. 3 and the softmax low-probability output prediction method of FIG. 4, but the softmax calculation method and the softmax low-probability output prediction method may be performed by the computer system shown in FIG. 5.

Referring to FIG. 5, a computer system 1000 may include at least one of a processor 1010, a memory 1030, an input interface device 1050, an output interface device 1060, and a storage device 1040 that communicate with each other via a bus 1070. Also, the computer system 1000 may further include a communication device 1020 connected to a network. The processor 1010 may be a central processing unit (CPU) or a semiconductor device that executes instructions stored in the memory 1030 or the storage device 1040. The memory 1030 or the storage device 1040 may include various forms of volatile or non-volatile storage media. For example, the memory 1030 may include a read-only memory (ROM) or a random access memory (RAM). In an embodiment of the present disclosure, the memory 1030 may be inside or outside the processor 1010 and connected to the processor 1010 via various well-known devices. The memory 1030 is various forms of volatile or non-volatile storage media. For example, the memory 1030 may include a ROM or a RAM.

Therefore, embodiments of the present disclosure may be implemented as a method by a computer or implemented as a non-transitory computer-readable medium in which computer-executable instructions are stored. According to an embodiment, when executed by a processor, the computer-readable instructions may allow a method to be performed according to at least one aspect of the present disclosure.

The communication device 1020 may transmit or receive a wired signal or wireless signal.

A method according to an exemplary embodiment of the present disclosure may be implemented in the form of program instructions that are executable by various computing devices, and recorded on a computer-readable medium.

The computer-readable medium may include program instructions, data files, data structures, and the like solely or in combination. The program instructions recorded on the computer-readable medium may be specially designed and configured for embodiments of the present disclosure or may be known and available to those of ordinary skill in the field of computer software. Computer-readable recording media may include hardware devices configured to store and execute program instructions. For example, computer-readable recording media may be magnetic media such as a hard disk, a floppy disk, and magnetic tape, optical media such as a CD-ROM and a DVD, magneto-optical media such as a floptical disk, a ROM, a RAM, a flash memory, and the like. The program instructions include not only machine code such as code generated by a compiler, but also high-level language code that is executable by a computer using an interpreter or the like.

According to an exemplary embodiment of the present disclosure, it is possible to design a data flow and a hardware calculation device that lead to a reduction in latency and an increase in energy efficiency without degradation of the accuracy of an algorithm.

According to an exemplary embodiment of the present disclosure, it is possible to implement a hardware-efficient circuit for predicting a softmax low-probability output not by performing division with high calculation complexity on all elements existing in a softmax input vector but by skipping some unnecessary softmax calculations through a softmax low-probability prediction device with low calculation complexity when performing an attention which is a main mechanism of a transformer.

According to an exemplary embodiment of the present disclosure, a softmax low-probability prediction calculation is performed not by approximating the expression of an algorithm but by using an expression including an arithmetic mean and a geometric mean. Therefore, it is possible to reduce latency without degradation of accuracy and increase energy efficiency.

Effects that can be achieved from the present disclosure are not limited to those described above, and other effects that have not been described above will be clearly understood by those of ordinary skill in the art from the above description.

While the present disclosure has been described above with reference to exemplary embodiments thereof, those of ordinary skill in the art should understand that the present disclosure can be variously modified and altered without departing from the spirit and scope of the present disclosure stated in the following claims.

What is claimed is:

1. A circuit for predicting a softmax low-probability output for hardware-optimized quantized transformer calculation, the circuit comprising:
a first-in first-out (FIFO) memory configured to store all elements of a quantized input vector;
an accumulator configured to cumulatively add all the elements;
a shifter configured to calculate an arithmetic mean of all the elements by performing a right shift on a cumulative sum of all the elements;
a subtractor configured to calculate a result of subtracting the arithmetic mean from a specific one of all the elements; and
a comparator configured to compare the subtraction result with a specific constant.

2. The circuit of claim 1, wherein the specific constant is configured to be determined on the basis of a size of the input vector and a number of quantization bits applied to the input vector.

3. The circuit of claim 1, wherein a size of the input vector is represented as an integer power of 2.

4. A softmax calculator comprising:
a softmax low-probability output prediction circuit configured to calculate a result of subtracting an arithmetic mean of all elements of a quantized input vector from each element of the input vector and compare the subtraction result with a specific constant;
a controller configured to determine whether a softmax output for each of the elements corresponds to a low-probability output on the basis of a comparison result between the subtraction result and the specific constant;
a maximum searcher configured to search for a maximum value of all the elements;
an exponent calculator configured to:
receive a quantization scale, calculate original values and an original maximum value of all the elements by multiplying all the elements and the maximum value of all the elements by the quantization scale, and
calculate, for all the elements of the input vector, values of an exponentiation function that has a difference between each of the original values and the original maximum value as an exponent and Euler's number as a base;
a divider; and
an accumulator included in the softmax low-probability output prediction circuit configured to cumulatively add the values of the exponentiation function,
the divider configured to calculate a softmax value for a specific one of all the elements on the basis of a cumulative sum of the values of the exponentiation function and a value of the exponentiation function, and
in response to a softmax output for the specific element corresponding to a low-probability output, the controller configured to set the divider to an inactive state and control an output part to output the softmax output for the specific element as 0.

5. The softmax calculator of claim 4, wherein the specific constant is configured to be determined on the basis of a size of the input vector and a number of quantization bits applied to the input vector.

6. The softmax calculator of claim 4, wherein a size of the input vector is represented as an integer power of 2.

7. The softmax calculator of claim 4, wherein the softmax low-probability output prediction circuit comprises:
a first-input first-output (FIFO) memory configured to store all the elements;
the accumulator configured to cumulatively add all the elements;
a shifter configured to calculate the arithmetic mean by performing a right shift on a cumulative sum of all the elements;
a subtractor configured to calculate a result of subtracting the arithmetic mean from the specific one of all the elements; and
a comparator configured to compare the subtraction result with the specific constant, and
the accumulator comprising a low-precision adder and a high-precision adder,
the low-precision adder configured to perform addition using a smaller number of bits than the high-precision adder,
the low-precision adder configured to be used for cumulatively adding all the elements, and
the high-precision adder configured to be used for cumulatively adding the values of the exponentiation function.

8. A method of predicting a softmax low-probability output which is for hardware-optimized quantized transformer calculation, the method comprising:
storing all elements of a quantized input vector in a first-input first-output (FIFO) memory;
cumulatively adding all the elements using an accumulator;
performing, by a shifter, a right shift on a cumulative sum of all the elements to calculate an arithmetic mean of all the elements;
calculating, by a subtractor, a result of subtracting the arithmetic mean from a specific one of all the elements; and
comparing, by a comparator, the subtraction result with a specific constant and determining, by a controller, whether a softmax output for the specific element corresponds to a low-probability output on the basis of a comparison result between the subtraction result and the specific constant.

9. The method of claim 8, wherein the specific constant is determined on the basis of a size of the input vector and a number of quantization bits applied to the input vector.

10. The method of claim 8, wherein a size of the input vector is represented as an integer power of 2.
